(19) United States
(12) Patent Application Publication
(10) Pub. No.: US 2026/0088490 A1
(43) Pub. Date: Mar. 26, 2026

(54) WIRELESS FIELD DEVICE WITH CARTRIDGE CONNECTOR

(71) Applicant: Rosemount Inc., Shakopee, MN (US)

(72) Inventors: Nathan Holm, Mound, MN (US); Greg Gindele, Maple Lake, MN (US)

(21) Appl. No.: 18/893,087

(22) Filed: Sep. 23, 2024

(51) Int. Cl. H01Q 1/50; H01Q 1/22

(52) U.S. Cl. CPC H01Q 1/50; H01Q 1/22

(57) ABSTRACT

A field device includes a housing. Field device electronics are disposed within the housing and include wireless communication circuitry. An antenna assembly includes an antenna base engaged within an opening in the housing. The antenna assembly includes an antenna engaged with the antenna base and operably coupled to the wireless communication circuitry with an internal electrical connection through the antenna base. A connector cartridge with a first coaxial cable interface operably couples to the internal electrical connection. The antenna including a second coaxial cable interface configured to operably engage the first coaxial cable interface The connector cartridge having a body with an exterior geometry which engages an interior geometry of a bore in the antenna base to fixedly mount the connector cartridge within the antenna base.

### BACKGROUND

The present invention relates to industrial process control or monitoring systems. More specifically, the present invention relates to process variable transmitters with wireless communication.

In industrial settings, control systems are used to monitor and process inventories of industrial and chemical processes, and the like. Typically, the control system performs these functions using field devices, such as process variable transmitters, distributed at key locations in the industrial process that are coupled to control circuitry in the control room by a process control loop.

Field devices are used by the process control and measurement industry for a variety of purposes. Usually, such devices have a field-hardened enclosure so that they can be installed outdoors or in relatively rugged environments and be able to withstand extremes of temperature, humidity, vibration, and mechanical shock.

Some field devices include a transducer. A transducer is understood to mean either a device that generates an electrical output based on a physical input (such as a sensor) or that generates a physical output, such as a valve control signal, based on an electrical input signal. Typically, a transducer transforms an input into an output having a different form. Types of transducers include various analytical equipment, pressure sensors, thermistors, thermocouples, strain gauges, flow transmitters, positioners, actuators, solenoids, indicator lights, and others. Transducers can be used to monitor and control the variables of various industrial and chemical processes. These variables are generally referred to as process variables and can include flow rates, pressures, differential pressures, temperatures, tank levels, valve positions, and the like.

Typically, each field device also includes communication circuitry that is used for communicating with a process control room, or other circuitry, over a process control loop. In some installations, the process control loop is also used to deliver a regulated current and/or voltage to the field device for powering the field device. In some installations, wireless technologies are used to communicate with field devices. Wireless operation simplifies field device wiring and setup.

In general, wireless radio-frequency communication requires the use of an antenna. An antenna may be provided internally within the field device, or it may be located external to the field device. In harsh industrial settings, an external antenna is a relatively fragile physical component and should the antenna break off, or the connection between the antenna and the field device housing be damaged, communication to the field device itself may be compromised. If the antenna seal to the housing is damaged or degraded (for example by UV exposure or hydrolytic degradation) the environmental seal can fail and cause damage to the field device and loss of communication. Generally, the antenna and the connection between the field device housing (which is typically metal) must withstand high vibration levels, impact, and extreme temperatures while maintaining a weather-tight seal.

In some installations, due to needed signal strength, wireless communication circuitry is located inside each field device and connected to a much larger externally mounted antenna that is coupled to the field device. An externally mounted antenna may be mounted at a distance from the housing and electrically connected to the wireless communication circuitry with an external electrical connection, such as with a coaxial cable. The external electrical connection of the antenna is connected to the field device by an antenna base or mount, which is coupled to the field device. The antenna base protects an electrical connection between the wireless communication circuitry and the antenna and said antenna base may be provided in various configurations with different geometries and dimensions. One such example is shown in U.S. Pat. No. 8,362,959, issued Jan. 29, 2013 to Rosemount Inc. and entitled WIRELESS FIELD DEVICE WITH RUGGED ANTENNA AND ROTATION STOP. This invention relates to an industrial field device that can be configured to operate with various antenna structures that may be rotatable to different orientations. An antenna base may be provided with a rotation stop that protects the internal electrical connection between the wireless communication circuitry and the antenna from damage when the antenna is rotated.

### SUMMARY

A field device includes a housing with field device electronics disposed within the housing. The field device electronics include wireless communication circuitry. An antenna assembly includes an antenna base engaged within an opening in the housing. The antenna assembly includes an antenna engaged with the antenna base and operably coupled to the wireless communication circuitry with an internal electrical connection. A connector cartridge with a first coaxial cable interface operably couples to the internal electrical connection, the antenna including a second coaxial cable interface to operably engage the first coaxial cable interface. The connector cartridge has a body with an exterior geometry which engages an interior geometry of a bore in the antenna base to fixedly mount the connector cartridge within the antenna base.

An antenna assembly for a field device includes an antenna base disposed on a field device housing. The housing includes wireless communication circuitry configured to communicate wireless process information. An antenna is engaged with the antenna base and operably coupled to the wireless communication circuitry with a coaxial cable. A connector cartridge with a body including a first end is coupled to the coaxial cable and a second end includes a coaxial cable interface. The connector cartridge is mounted within a bore in the antenna base. The cartridge body has an exterior geometry which corresponds to an interior geometry of the bore to fixedly mount the coaxial cable interface within the antenna base and couple the wireless communication circuitry with the antenna.

This Summary and Abstract are provided herein to introduce a selection of concepts in simplified form that are further described below in the Detailed Description. The Summary and Abstract are not intended to identify key features or essential features of the claimed subject matter, nor are they intended to be used as an aid in determining the scope of the claimed subject matter. The claimed subject matter is not limited to the implementations that solve any or all the disadvantages noted in the background.

### BRIEF DESCRIPTION OF THE DRAWINGS

FIG. 1 is a block diagram of a field device in accordance with an embodiment of the present invention.

FIG. 2A is a side view of a field device in accordance with an embodiment of the present invention.

FIG. 2B is a side view of a field device having an antenna assembly in accordance with an embodiment of the present invention.

FIG. 2C is a partial cross-sectional view of a field device having an antenna assembly in accordance with an embodiment of the present invention.

FIG. 3 is an enlarged cross-sectional view showing the specific engagement of a coaxial cable connector cartridge with a bore of a field device antenna base in accordance with an embodiment of the present invention.

FIG. 4 is an enlarged side view of a coaxial cable connector cartridge in accordance with an embodiment of the present invention.

FIG. 5 is a perspective view of a coaxial cable connector cartridge being inserted in a bore of a field device antenna base in accordance with an embodiment of the present invention.

### DETAILED DESCRIPTION

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

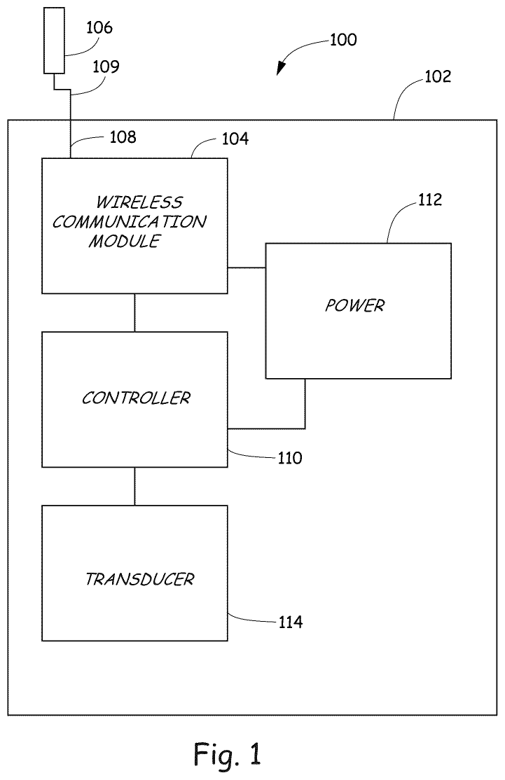

FIG. 1 is a block diagram of a wireless field device in accordance with an embodiment of the present invention. Wireless field device 100 includes housing 102 illustrated diagrammatically as a rectangular box. However, the rectangular box is not intended to depict the actual shape of the housing 102. Wireless communication module 104 is disposed within housing 102 and is electrically coupled to antenna 106 via internal electrical connection 108 and external electrical connection 109. Wireless communication module 104 is also coupled to controller 110 as well as power module 112. Wireless communication module 104 includes any suitable circuitry useful for generating radio frequency signals.

Depending on the application, wireless communication module 104 may be adapted to communication in accordance with any suitable wireless communication protocol. One type of wireless communication system is a specialized wireless communication standard designed to allow process transmitters to communicate with specialized gateways or specialized handheld devices that are not used outside the process control industry. Examples of such wireless communication modules include modules that use the WirelessHART® communication standard, or any type of wireless signal, and that can be mounted within the transmitter housing. In the embodiment illustrated in FIG. 1, wireless communication module 104 is a component within housing 102 that is coupled to an external antenna 106 via external electrical connection 109. However, this is exemplary only, and antenna 106 may be mounted on housing 102 without external electrical connection 109.

Controller 110 is coupled to wireless communication module 104 and communications bi-directionally with wireless communication module 104. Controller 110 includes a microprocessor but can also include suitable support circuitry such as onboard memory, communication busses, et cetera.

Each wireless communication module 104 and controller 110 is coupled to power module 112. Power module 112 may preferably supply all requisite electrical energy for the operation of field device 102 to wireless communication module 104 and controller 110. Power module 112 includes any device that is able to supply stored or generated electricity to wireless communication module 104 and controller 110. Examples of devices that can comprise power module 112 include batteries (rechargeable or otherwise), capacitors, solar arrays, thermoelectric generators, vibration-based generators, wind-based generators, fuel cells, et cetera. Alternatively, power module 112 may be connected to a two-wire process control loop and obtain and store power for use by the wireless communication module. Further, power module 112 may be simply connected to an external power source which provides, for example, a 24-volt supply.

Transducer 114 is coupled to controller 110 and interfaces field device 100 to a physical process. Examples of transducers include sensors, actuators, solenoids, indicator lights, et cetera. Essentially, transducer 114 is any device that is able to transform a signal from controller 110 into a physical manifestation, such as a valve movement, or any device that generates an electrical signal to controller 110 based upon a process variable, such as a process fluid pressure.

An external electrical connection between the wireless communication circuitry and the antenna can be provided by a coaxial cable using various commercially available connection types such as an N-type connector or MMCX type connector interface. N-type connectors are coaxial RF connectors with a standard threaded connection point. Some N-type connectors are designed to be weatherproof and robust and are available with a large range of RF specifications and internal components. However, typical N-type connectors are limited in attachment styles to an external geometry of a straight or right-angled connector jack. These limited N-type attachment styles restrict the angular degree of freedom and attachment points available. These attachment style restrictions create design and manufacturability challenges in field devices that may require significant workarounds to maintain weatherproof status of the device, require extra components or large additions to the field device, or impose accessibility issues.

Embodiments of the present invention generally provide a field device with an industrial antenna mounting configuration that uses an external electrical connection to couple the antenna to the wireless communication module via an internal electrical connection. Preferably, the electrical connection is provided by a coaxial cable using an N-type connection. Embodiments of the present invention provide an N-type coaxial cable connector cartridge to couple wireless communication circuitry in a field device to an external antenna. The connector cartridge has a standardized, or universal, external geometry that may be inserted into a cartridge receiving bore in an antenna base with a corresponding standardized internal geometry that seals a field device housing from the environment and provides standard connection point properties. Embodiments of the present invention use the internal components of a coaxial cable interface, such as an N-type connector, but allows an antenna assembly to be designed as needed in any internal or external geometry or configuration without being limited by the angular degree of freedom and attachment point of a standard N-type coaxial cable connector. The connector cartridge and antenna base bore may be standardized and implemented to reduce the complexity in field device manufacturing by removing expensive or burdensome workarounds for standard commercially available connection styles, lower costs, and reduce field accessibility concerns.

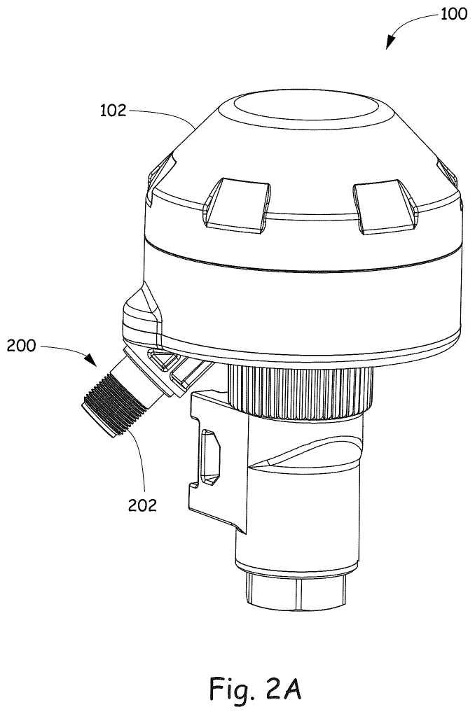

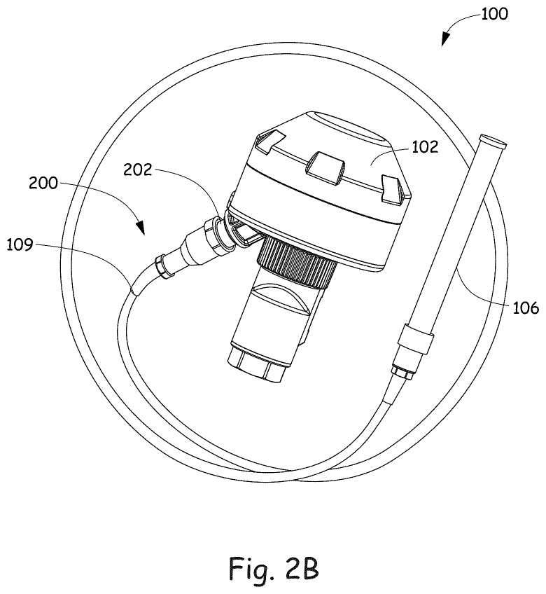

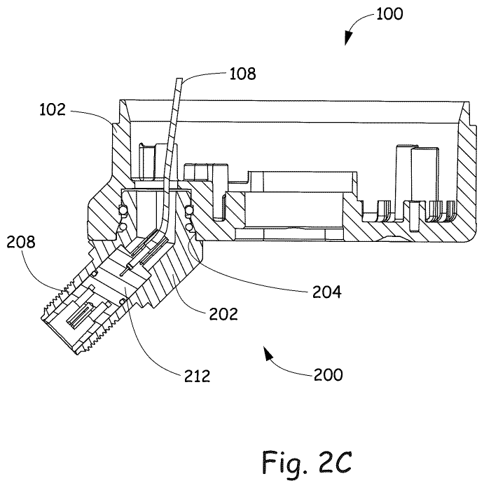

FIG. 2A is a side view of a field device having an antenna assembly in accordance with an embodiment of the present invention. Field device 100 can be any suitable field device and generally includes housing 102 containing device electronics therein. As shown in FIG. 2A, field device 100 includes antenna assembly 200 mounted on field device housing 102. Antenna assembly 200 includes antenna base 202 coupled to the field device housing 102 which provides structural support and internal connections to antenna 106 (not shown). As illustrated, antenna base 202 is shown with an external geometry that extends downward at an angle away from housing 102. However, embodiments of the present invention enable the flexibility for antenna assembly 200 to be configured with customized external and internal geometries while using an external electrical connection, such as a coaxial cable interface, to operably couple the wireless communication module 104 and antenna 106.

FIG. 2B is a side view of a field device 100 having an antenna assembly in accordance with an embodiment of the present invention. Similar to FIG. 2A, field device 100 includes antenna assembly 200 mounted on field device housing 102. Antenna assembly 200 includes antenna base 202 coupled to the field device housing 102. As illustrated, antenna 106 is shown here coupled to antenna base 202 by external electrical connection 109. In this embodiment, antenna 106 is configured to be placed a distance from the field device 100 and is coupled to an elongated coaxial cable 109 which is coupled to antenna base 202.

FIG. 2C is a partial cross-sectional view of a field device 100 having an antenna assembly in accordance with an embodiment of the present invention. As shown in FIG. 2C, antenna assembly 200 includes antenna base 202 that fits within opening 204 of field device housing 102. Antenna base 202 may be inserted into opening 204, which is preferably a tapered hole in housing 102, and retained therein with a water-tight seal. As illustrated in FIG. 2C, internal electrical connection 108 runs from the wireless communication module 104 (shown in FIG. 1) in housing 102 and is sealed within antenna base 202 where it terminates at connector cartridge 212 to provide a coaxial cable interface, such as an N-type connection. Antenna 106 (not shown) may be coupled to connector cartridge 212 within antenna base 202 while maintaining an environmental seal. Antenna base 202 includes an externally threaded region 208 of a female coaxial cable interface that corresponds to an internal threaded region of a male coaxial cable interface.

As illustrated in FIG. 2C, the axis of opening 204 in field device housing 102 is oriented at an angle such that antenna base 202 extends below housing 102 such that it would orient the external electrical connection 109 of antenna 106 down and to the side of housing 102. However, as discussed above, connector cartridge 212 enables antenna base 202 to be configured in any external geometry while utilizing a standard coaxial cable interface, such as an N-type connection, to couple an antenna 106 to an internal electrical connection 108.

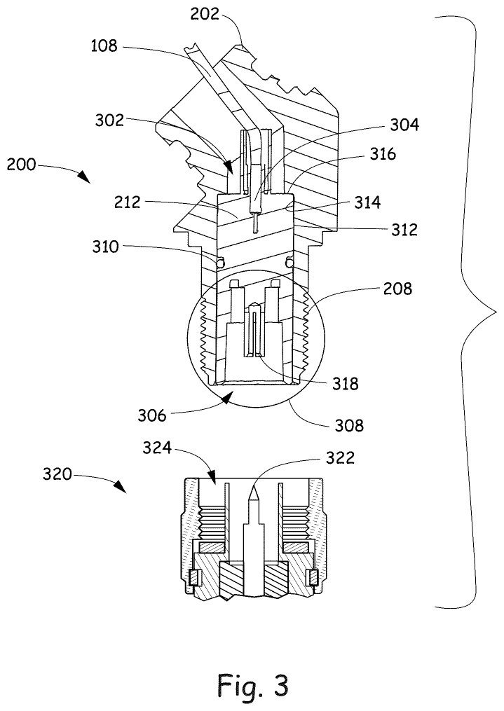

FIG. 3 is an enlarged cross-sectional view of antenna assembly 200 showing the specific engagement of coaxial cable connector cartridge 212 within a bore 312 of antenna base 202. As can illustrated, cartridge 212 has a body 314 with an external geometry that corresponds to a matching internal geometry of bore 312. Sealing member or O-ring 310 is disposed on the exterior circumference of cartridge 212 to provide friction to hold the connector cartridge 212 within the bore 312 of the antenna base 202. Connector cartridge 212 includes a first end 302 coupled with attachment 304 of the internal electrical connection 108 and a second end 306 which includes a standard N-type female coaxial cable interface 308 (as shown within the circled portion of second end 306) which may couple to a corresponding male coaxial cable interface of an external electrical connection 109. Cartridge 212 converts the internal electrical connection 108 to a standard coaxial cable interface and includes the components of a female interface of a N-type coaxial cable. For example, a coaxial cable generally includes an inner core made of copper surrounded by an inner dielectric insulator, followed by a metallic shield and outer plastic sheath.

Connector cartridge 212 may be press fit into bore 312 to provide an environmental seal. Antenna base 202 further includes a lip 316 within bore 312 and forms part of the internal geometry of bore 312. As illustrated, when connector cartridge 212 is engaged within bore 312, a portion of the first end 302 abuts lip 316. Lip 316 stops the first end 302 of cartridge 212 within bore 312 and frictionally engages the cartridge 212 within antenna base 202.

FIG. 3 further illustrates a male coaxial cable interface which may be provided on a coaxial cable or antenna to couple with the female interface 308. As illustrated, cartridge 212 includes the components of a female connector of an N-type coaxial cable interface 308. Coaxial connectors are designed to maintain a coaxial form across the connection and the female connector, or jack, of an N-type cable interface 308 includes socket 318 which is configured to engage a pin of a male connector, or plug, of an N-type cable interface. Male coaxial connector 320 includes pin 322 to operably engage the socket 318 of cable interface 308 when connecting the coaxial cable 109 (not shown) to the cartridge 212. Male connector 320 further includes an internally threaded region 324 which corresponds to the externally threaded region 208 on the antenna base 202. When male connector 320 is threadably engaged with the antenna base 202, the cartridge interface 308 couples with the pin 322 of the male coaxial interface 320 and the coaxial cable connection is complete, enabling antenna 106 to be operably coupled with the wireless communication module 104.

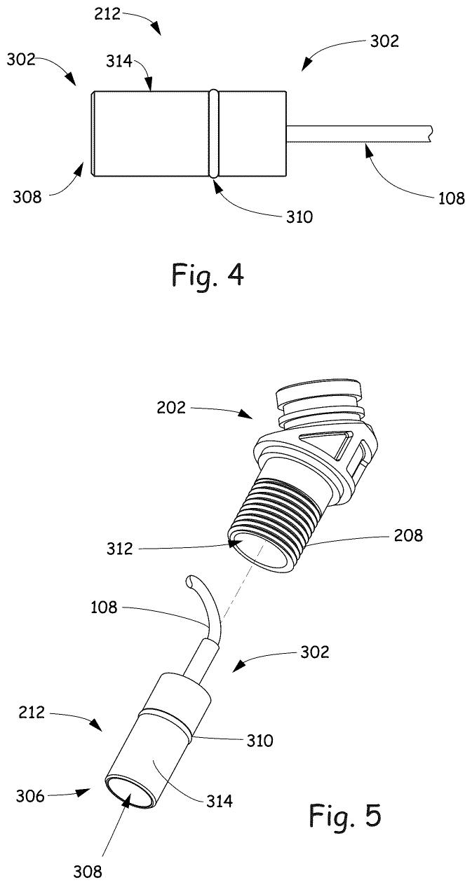

FIG. 4 is an enlarged side view of connector cartridge 212. The body 314 of cartridge 212 preferably has an external geometry of a cylinder which corresponds to the internal geometry of bore 312. However, embodiments of the present invention can be practiced with any suitable corresponding geometries to provide a standardized connector cartridge and antenna base bore mating geometry for coupling a coaxial cable interface to a field device. As illustrated, the internal electrical connection 108 couples to first end 302 of the cartridge 212. The second end 302 provides the external electrical connection interface 308 which is preferably a female N-type coaxial cable interface.

As discussed above, the cartridge connector enables the field device 100 to be connected to an antenna using a standard coaxial cable interface but using an antenna base configured with any external geometry. Thus, an antenna base may be configured with different external geometries that would typically not be useable with a commercially available coaxial cable interface, which typically are only available as a straight or right-angled connector jack. This connector cartridge allows for greater flexibility in designing an antenna mount to account for different field accessibility concerns. For example, in circumstances when a large antenna is required or an antenna must be placed a distance from the field device, an antenna may be placed in a suitable location spaced from the field device and coupled to the field device through a coaxial cable. In other circumstances, the antenna may be directly coupled to the antenna mount through coaxial cable interface of the cartridge.

As illustrated, a sealing member or O-ring 310 is provided on an external circumference of cartridge 212 which may be disposed in a recess of the external geometry of body 314. In one example, O-ring 310 may be an elastomeric O-ring such as silicon. Preferably, one or more O-rings are interposed between an exterior surface of cartridge 212 and an interior surface of the bore 312 to provide friction to hold the cartridge 212 within the antenna base 202 and provide a water-tight seal. While the cartridge is illustrated with O-rings to fixedly engage within a bore of an antenna base, the present invention need not be so limited, and embodiments of the present invention may also include the utilization of other means, such as press fitting, mechanical fasteners, or other suitable means, to secure cartridge 212 within antenna base 202 and provide an environmental seal.

FIG. 5 is a perspective view of connector cartridge 212 being inserted in a bore 312 of a field device antenna base 202. As illustrated, the first end 302 of cartridge 212, which is connected to electrical connection 106, is inserted into bore 312 of antenna base 202. For illustrative purposes only, coaxial cable 108 is shown disconnected, but it is to be understood cable 108 would extend from cartridge 212 within antenna base 202 to couple with wireless field device electronics in housing 102. Body 314 of cartridge 212 has an external geometry corresponding to the internal geometry of bore 312 such that first end 302 may be slid into the opening of bore 312 and the body 314 press fit within bore 312 to frictionally engage the cartridge 212 within antenna base 202. A portion of the first end 302 of cartridge 212 may further engage lip 316 (as shown in FIG. 3) inside bore 312. In one embodiment, the press fit assembly creates an irreversible mate between the bore 312 and cartridge 212.

The second end 306 of cartridge 212 extends away from antenna base 202 enabling the interface 308 to be accessible to the male connector 320 when connecting the antenna 106 (not shown) to the antenna base 202. Antenna base 202 includes an externally threaded region 208 that accepts a cooperative internally threaded region of male connector 320 (See, FIG. 3). Antenna base 202 may therefore be designed or configured as required in various shapes or internal and external geometries and include the standardized mating geometries between cartridge 212 and bore 312. The present invention thus provides a connector cartridge that allows any required or custom antenna assembly geometry to use a standard electrical connection interface, such as the standard N-type interface, with a customizable jack mounting style. The cartridge reduces the need for extensive workarounds to maintain weatherproof status and accessibility while avoiding manufacturing complexity and design obstacles. Additionally, the cartridge is economical due to the use of standard internal components, e.g., the components of an N-type interface, while allowing increased flexibility and space efficiency when a standard interface is required.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

Although the present invention has been described with reference to preferred embodiments, workers skilled in the art will recognize that changes may be made in form and detail without departing from the spirit and scope of the invention.

What is claimed IS:

1. A field device comprising:
a housing;
field device electronics disposed within the housing, the field device electronics including wireless communication circuitry;
an antenna assembly including an antenna base engaged within an opening in the housing, the antenna assembly including an antenna engaged with the antenna base and operably coupled to the wireless communication circuitry with an internal electrical connection through the antenna base; and
a connector cartridge with a first coaxial cable interface operably couples to the internal electrical connection, the antenna including a second coaxial cable interface configured to operably engage the first coaxial cable interface, the connector cartridge having a body with an exterior geometry which engages an interior geometry of a bore in the antenna base to fixedly mount the connector cartridge within the antenna base.

2. The field device of claim 1, wherein the bore in the antenna base includes a lip that abuts the body of the connector cartridge when fixedly mounted within the antenna base.

3. The field device of claim 1, wherein the connector cartridge includes the internal components of a coaxial cable interface.

4. The field device of claim 3, wherein the coaxial cable interface is an N-type coaxial cable interface.

5. The field device of claim 1, wherein the coaxial cable interface is a MMCX coaxial cable interface.

6. The field device of claim 4, wherein the antenna is electrically coupled to the wireless communication circuitry by the N-type coaxial cable interface.

7. The field device of claim 1, wherein the connector cartridge body has a first end coupled to the internal electrical connection and a second end including a female coaxial cable interface.

8. The field device of claim 7, wherein the first end of the connector cartridge is press fit into the bore of the antenna base.

9. The field device of claim 1, wherein the cartridge body has a cylindrical exterior geometry which corresponds to a cylindrical interior geometry of the bore in the antenna base.

10. The field device of claim 1, and further comprising at least one sealing member disposed on an exterior circumference of the body of the cartridge connector.

11. The field device of claim 10, wherein the at least one sealing member is disposed in a recess on the exterior circumference of the cartridge body.

12. The field device of claim 10, wherein the at least one sealing member is interposed between the outer circumference of the cartridge body and an inner surface of the bore of the antenna base.

13. The field device of claim 12, wherein the at least one sealing member is configured to generate friction to secure the cartridge within the bore of the antenna base.

14. The field device of claim 10, wherein the at least one sealing member provides an environmental seal.

15. The field device of claim 1, wherein the cartridge is press fit into the bore of the antenna base to form an environmental seal.

16. The field device of claim 15, wherein the press fit assembly creates an irreversible mate between the bore and the cartridge.

17. The field device of claim 1, wherein the antenna base may be configured in any external geometry and provided with the cartridge connector and antenna base bore standardized mating geometry.

18. The field device of claim 1, wherein the antenna is coupled to the cartridge connector by a coaxial cable.

19. An antenna assembly for a field device comprising:
an antenna base disposed on a field device housing, the housing including wireless communication circuitry configured to communicate wireless process information;
an external antenna with a coaxial cable engaged with the antenna base, the external antenna operably coupled to the wireless communication circuitry with an internal electrical connection; and
a connector cartridge with a body including a first end coupled to the internal electrical connection and a second end including a first coaxial cable interface, the coaxial cable with a second coaxial cable interface operably engaged with the first coaxial interface, wherein the connector cartridge is mounted within a bore in the antenna base, the cartridge body having an exterior geometry which corresponds to an interior geometry of the bore to fixedly mount the first coaxial cable interface within the antenna base and couple the wireless communication circuitry with the antenna.

20. The antenna assembly of claim 19, wherein the coaxial cable interface is an N-type coaxial cable interface.
